(19) United States
(12) Patent Application Publication
(10) Pub. No.: US 2023/0381794 A1
(43) Pub. Date: Nov. 30, 2023

(54) ROTARY SHEET-SHAPED WATER STRUCTURE AND SHOWER HEAD HAVING THE STRUCTURE

(71) Applicant: Xiamen Delmei Sanitary Ware Co., Ltd, Xiamen (CN)

(72) Inventors: Changzheng NI, Xiamen (CN); Yongqiang YAN, Fuzhou (CN); Chunhua WANG, Xiamen (CN); Pingqing ZHANG, Xiamen (CN)

(21) Appl. No.: 17/887,221

(22) Filed: Aug. 12, 2022

(30) Foreign Application Priority Data
May 24, 2022 (CN) 202221498156.3

(51) Int. Cl. B05B 1/18

(52) U.S. Cl. CPC B05B 1/18

(57) ABSTRACT

The present disclosure provides a rotary sheet-shaped water structure, including a shell assembly and a gear assembly disposed inside the shell assembly. The shell assembly includes a water inlet and a water outlet. Water flows through the gear assembly through the water inlet and is sprayed out of the water outlet. The water inlet has a plurality of oblique surfaces and the water outlet has a water delivery nozzle having a long conical section. In this case, water enters obliquely to impact the gear assembly and flows toward the water delivery nozzle of long conical section at a lower speed, so as to ensure the water sprays can flow out in the form of rotary sheet-shaped structures. The rotary sheet-shaped water structure features less parts, simple structure, easy assembling, stable water delivery, beautiful water sprays and impact comfort.

### CROSS-REFERENCE TO RELATED APPLICATION

This application claims priority from the Chinese patent application 202221498156.3 filed May 24, 2022, the content of which is incorporated herein in the entirety by reference.

### TECHNICAL FIELD

The present disclosure relates to the technical field of bathroom products and in particular to a rotary sheet-shaped water structure and a shower head having the structure.

### BACKGROUND

Conventional shower heads have an increasing number of water spray patterns which result in different shower modes and degrees of comfort. Typical sheet-shaped water structures are fixed, which may cause the delivery of sheet-shaped water sprays to be non-uniformly spread and cause discomfort to users. Further, conventional designs have a complex structure and include many different parts, increasing production costs.

### SUMMARY

In order to solve the above problems, the present disclosure provides a rotary sheet-shaped water structure and a shower head having the structure.

In order to achieve the above purpose, the present disclosure adopts the following technical solution.

There is provided a rotary sheet-shaped water structure, including a shell assembly and a gear assembly disposed inside the shell assembly. The shell assembly includes a water inlet and a water outlet. Water flows through the gear assembly through the water inlet and is sprayed out of the water outlet. The water inlet has a plurality of oblique surfaces and the water outlet has a water delivery nozzle having a long conical section.

Preferably, the shell assembly includes a body and a cover body covered on the body. The body has a chamber with an opening disposed at an end. The cover body is covered on the opening, the water inlet is disposed on the cover body, the water outlet is disposed on the body, and the gear assembly is accommodated in the chamber.

Preferably, a second sealing ring is disposed between the cover body and the opening.

Preferably, a connection wall is convexly disposed at an end of the water inlet away from the body, and a first sealing ring is sleeved on the connection wall.

Preferably, the gear assembly includes a first gear corresponding to the first water inlet and a second gear corresponding to the water outlet, and the first gear is engaged with the second gear.

Preferably, a water outlet piece is disposed on the water outlet, the water delivery nozzle with the long conical section is disposed on the water outlet piece, and the long conical section is a rectangular conical section or an obround conical section.

Preferably, the second gear is disposed at a side of the water outlet piece close to the water inlet.

Preferably, a flow shaping pad is inserted on the water outlet piece, and water flows through the flow shaping pad from the chamber and then flows toward the water delivery nozzle.

Preferably, an irregularly-shaped pad is disposed between the water outlet piece and the water outlet.

There is further provided a shower head having the rotary sheet-shaped water structure, including a shower head body and a water delivery panel covered on the shower head body. A plurality of water outlet holes are opened on the water delivery panel and the rotary sheet-shaped water structure is disposed on the water outlet holes.

The present disclosure has the following beneficial effects.

1) A gear assembly is disposed in the shell assembly of the rotary sheet-shaped water structure and the shell assembly is provided with a water inlet having oblique surfaces and a water delivery nozzle having a long conical section, such that the water flow enters obliquely to impact the gear assembly and flows toward the water delivery nozzle with the long conical section at a lower speed, ensuring water sprays can flow out in the form of the rotary sheet-shaped structure. The rotary sheet-shaped water structure features less parts, simple structure, easy assembling, stable water delivery, beautiful water sprays and impact comfort.

2) By disposing a flow shaping pad on the water outlet piece, the water flow can be shaped to an orderly flow by the flow shaping pad firstly and then sprayed out of the water delivery nozzle of long conical section, thereby ensuring the water spray effect.

### BRIEF DESCRIPTIONS OF THE DRAWINGS

The accompanying drawings described herein are provided to further understand the present disclosure and constitute a part of the present disclosure. The illustrative embodiments and their descriptions in the present disclosure are used to explain the present disclosure but not constitute improper limitation to the present disclosure.

FIG. 1 is an axonometric diagram 1 illustrating a rotary sheet-shaped water structure according to the present disclosure.

FIG. 2 is an axonometric diagram 2 illustrating a rotary sheet-shaped water structure according to the present disclosure.

FIG. 3 is an exploded view illustrating a rotary sheet-shaped water structure according to the present disclosure.

FIG. 4 is a sectional diagram 1 illustrating a rotary sheet-shaped water structure according to the present disclosure.

FIG. 5 is a sectional diagram 2 illustrating a rotary sheet-shaped water structure according to the present disclosure.

FIG. 6 is an axonometric diagram 1 illustrating a rotary sheet-shaped water structure applied to a shower head according to the present disclosure.

FIG. 7 is an axonometric diagram 2 illustrating a rotary sheet-shaped water structure applied to a shower head according to the present disclosure.

FIG. 8 is an exploded view illustrating a rotary sheet-shaped water structure applied to a shower head according to the present disclosure.

FIG. 9 is an exploded sectional view illustrating a rotary sheet-shaped water structure applied to a shower head according to the present disclosure.

FIG. 10 is a sectional diagram illustrating a rotary sheet-shaped water structure applied to a shower head according to the present disclosure.

The numerals of the drawings are described below:
1. rotary sheet-shaped water structure, 11. body, 12. cover body, 121. oblique surface, 13. first gear, 14. irregularly-shaped pad, 15. flow shaping pad, 16. water outlet piece, 161. second gear, 162. water delivery nozzle, 17. first sealing ring, 18. second sealing ring,
2. shower head body.

### DETAILED DESCRIPTIONS OF EMBODIMENTS

In order to make the technical problems to be solved, technical solutions and beneficial effects of the present disclosure clearer and more understandable, the present disclosure will be further described in detail in combination with accompanying drawings and embodiments. It should be understood that the specific embodiments described herein are used only to explain the present disclosure rather than limit the present disclosure.

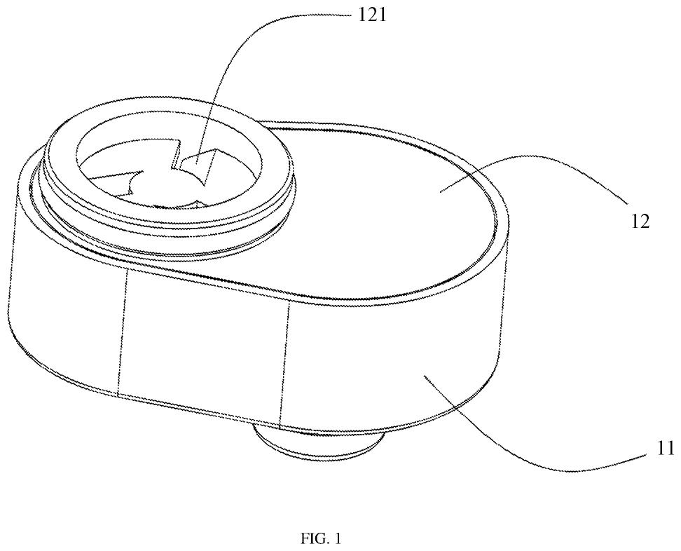

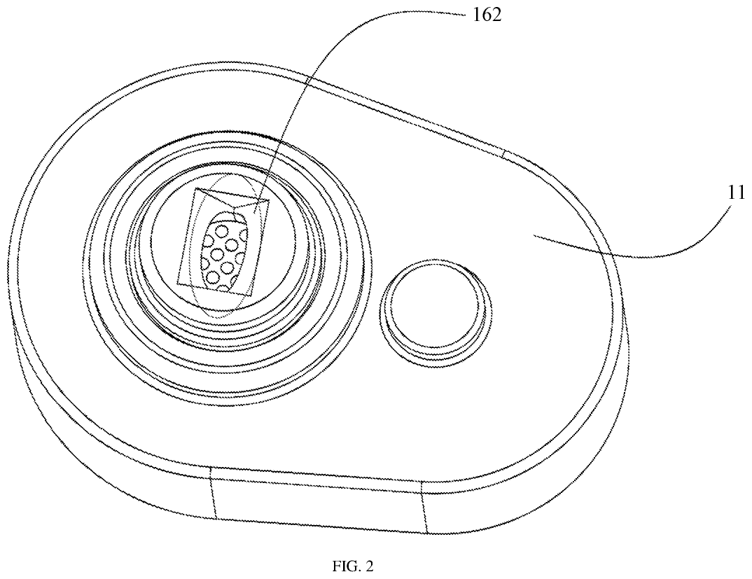

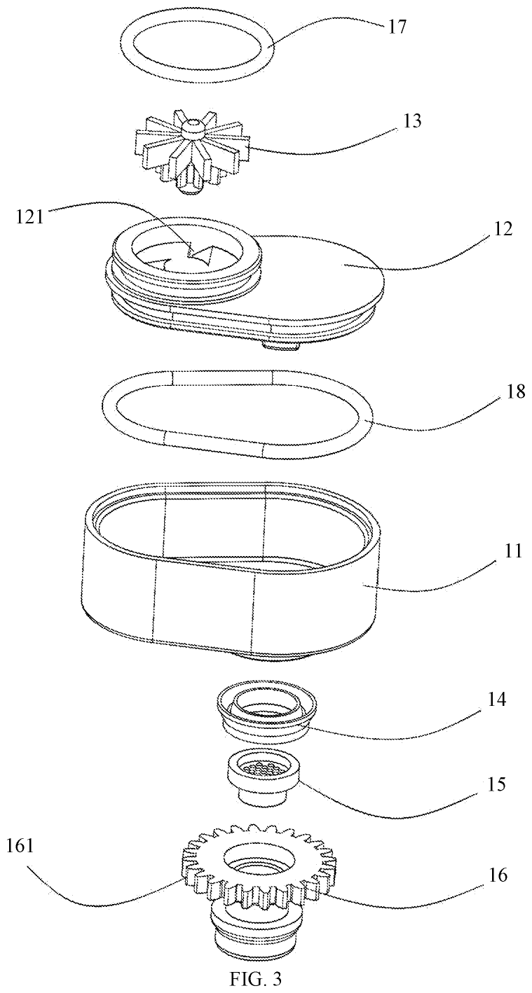

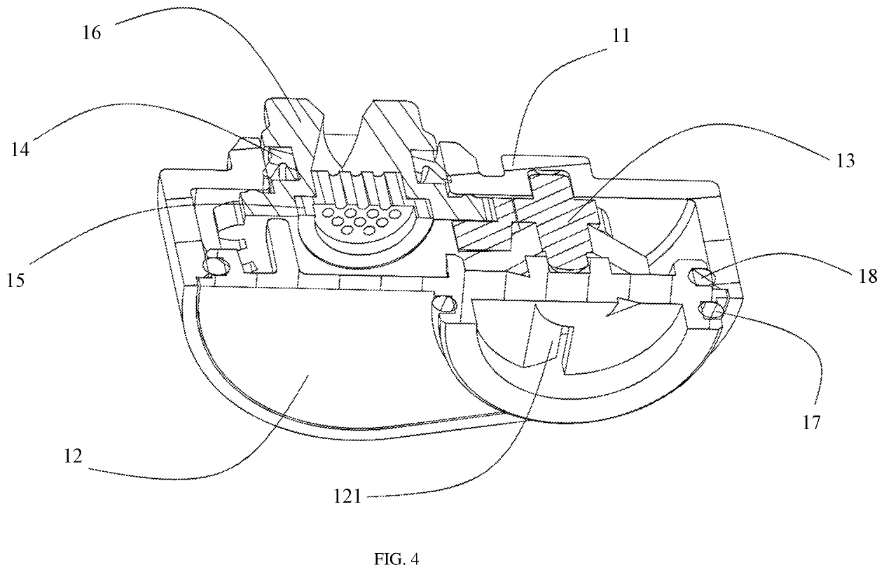

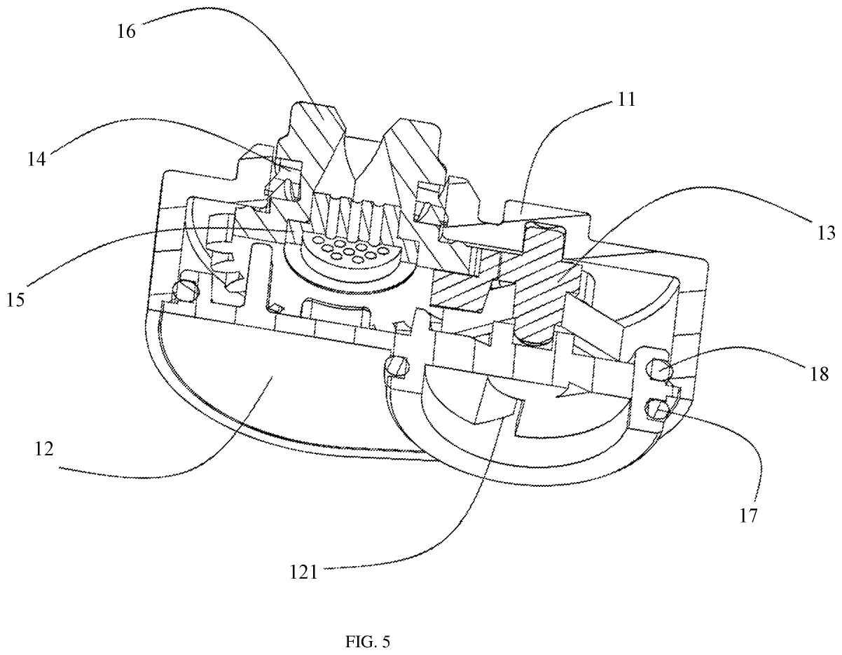

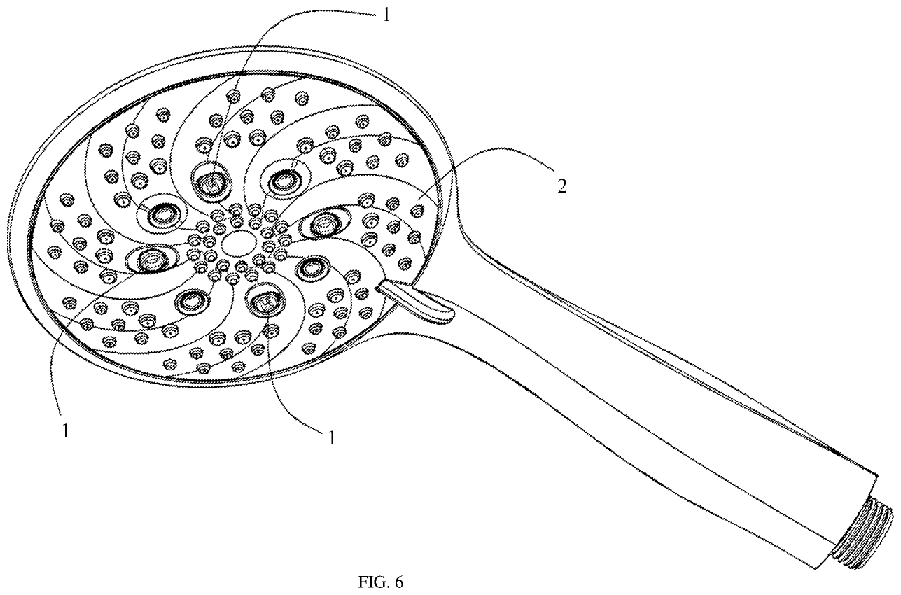

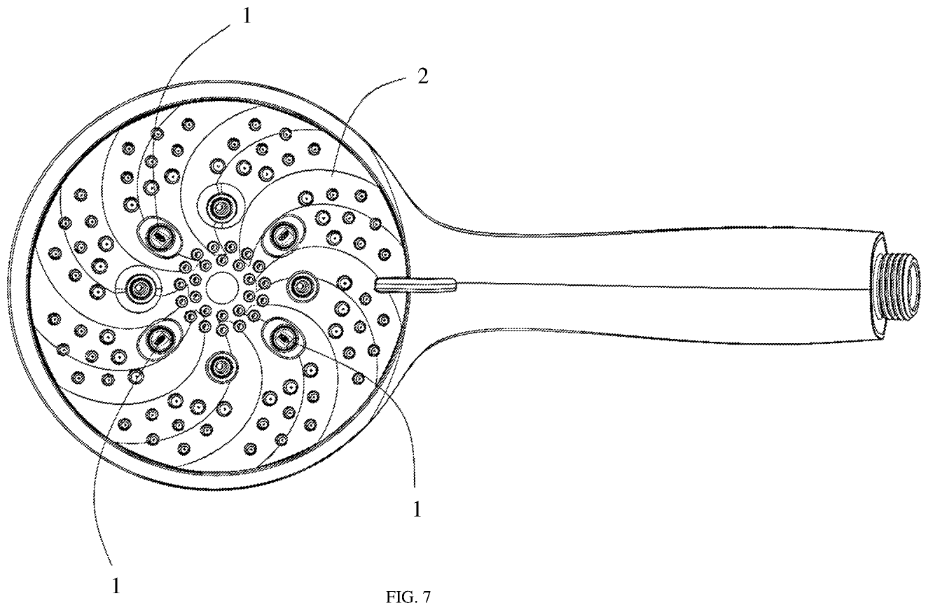

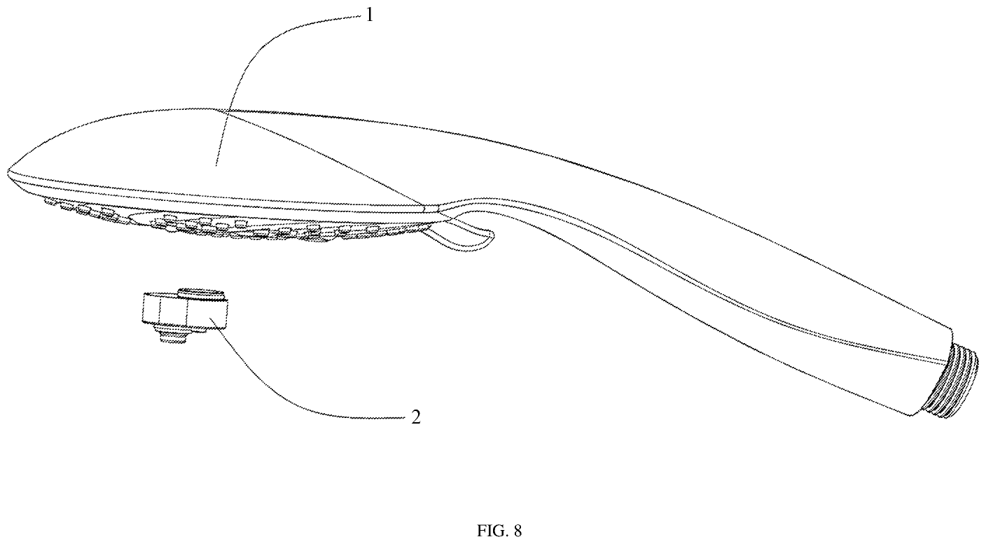

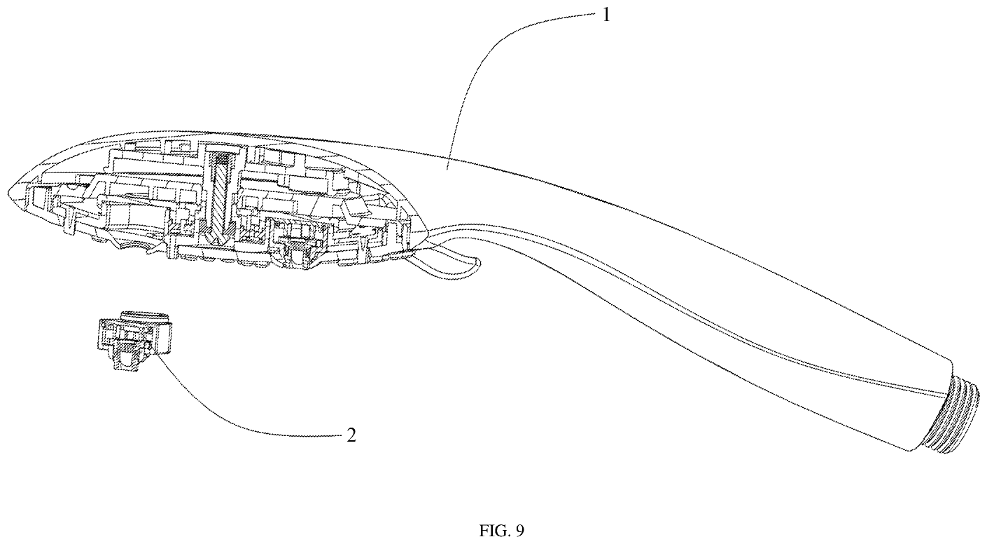

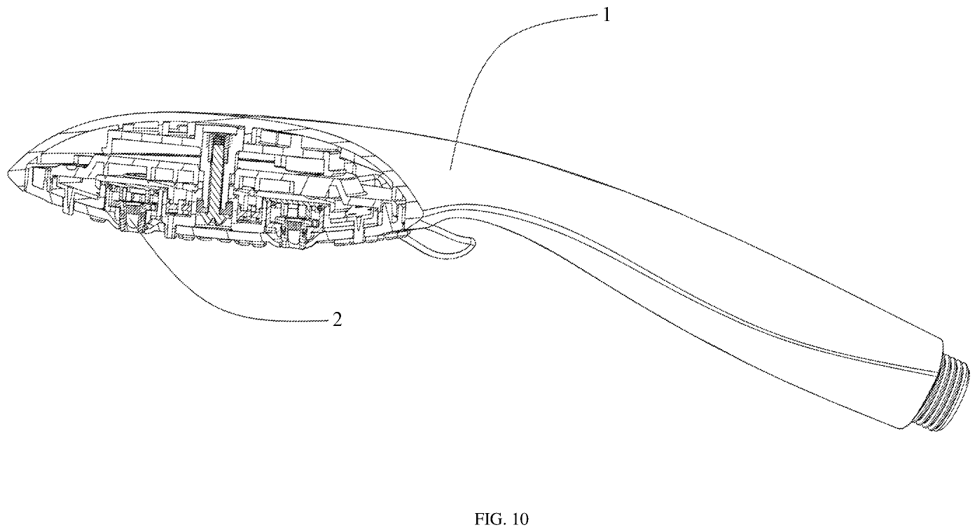

As shown in FIGS. 1 to 10, a preferred embodiment of the present disclosure provides a shower head having a rotary sheet-shaped water structure 1, including a shower head body 2 and a water delivery panel covered on the shower head body 2. A plurality of water outlet holes are disposed on the water delivery panel and the rotary sheet-shaped water structure 1 is disposed on a part of the water outlet holes. In addition, other water delivery spray structures are disposed on the water outlet holes to enable the water outflow to have corresponding water spray structures. The water flows towards the water delivery panel from the shower head body 2 and selectively flows out of the rotary sheet-shaped water structure 1 to form sheet-shaped water sprays.

The rotary sheet-shaped water structure 1 includes a shell assembly and a gear assembly disposed inside the shell assembly. The shell assembly includes a water inlet and a water outlet mutually opposed. Water flows through the gear assembly through the water inlet and is sprayed out of the water outlet.

The shell assembly includes a body 11 and a cover body 12 configured to cover the body 11. The body 11 has a chamber with an opening disposed at an end, and the cover body 12 covers the opening. The water inlet is disposed on the cover body 12, the water outlet opposed to the water inlet is disposed on the body 11, and the gear assembly is accommodated in the chamber.

The gear assembly includes a first gear 13 corresponding to the first water inlet and a second gear 161 corresponding to the water outlet, and the first gear 13 is engaged with the second gear 161. The first gear 13 has a smaller diameter than the second gear 161 and has a smaller gear number than the second gear 161. A protruding column is convexly disposed on end surfaces of both sides of the first gear 13 respectively and a groove corresponding to the protruding column is disposed inside the chamber and at an inner side of the cover body 12. The protruding column is fixed in the groove to enable the first gear 13 to be rotatably fixed in the chamber. The water inlet has a plurality of oblique surfaces 121. Water enters from the oblique surfaces 121 of the water inlet to obliquely impact the first gear 13 which drives the second gear 161 to rotate, and then flows out of the water outlet. Simultaneously, the water is made to flow at a lower speed.

A water outlet piece 16 is disposed on the water outlet. The second gear 161 is fixedly disposed at a side of the water outlet piece 16 close to the water inlet. When the water flow impacts the first gear 13 to drive the second gear 161 to rotate, the water outlet piece 16 rotates along with the second gear 161.

The water outlet is provided with a water delivery nozzle 162 with a long conical section. When the second gear 161 rotates, the water delivery nozzle 162 rotates along with the second gear 161. When water flows out of the water delivery nozzle 162 of long conical section in a rotary manner, rotary sheet-shaped water spray structures can be presented. The long conical section may be a rectangular conical section or an obround conical section or the like, which all fall within the scope of protection of the present disclosure as long as they can produce sheet-shaped water sprays.

A flow shaping pad 15 is further inserted on the water outlet piece 16. The water flows through the flow shaping pad 15 from the chamber to be shaped to an orderly flow and then flows toward the water delivery nozzle 162 of long conical section, thus ensuring that the orderly water sprays flow out.

An irregularly-shaped pad 4 is disposed between the water outlet piece 16 and the water outlet to ensure sealing performance at the time of relative rotation of the water outlet piece 16 and the water outlet.

A connection wall is convexly disposed at an end of the water inlet away from the body 11, and a first sealing ring 17 is sleeved on the connection wall. The first sealing ring 17 is used to seal a clearance between the rotary sheet-shaped water structure 1 and the water outlet holes. A second sealing ring 18 is disposed between the cover body 12 and the opening to seal a clearance between the cover body 12 and the body 11.

In the present disclosure, a gear assembly is disposed in the shell assembly of the rotary sheet-shaped water structure 1 and the shell assembly is provided with a water inlet having oblique surfaces 121 and a water delivery nozzle 162 having long conical section, such that the water enters obliquely to impact the gear assembly and flows toward the water delivery nozzle 162 with the long conical section at a lower speed, ensuring water sprays can flow in the form of the rotary sheet-shaped structure. The rotary sheet-shaped water structure features less parts, simple structure, easy assembling, stable water delivery, beautiful water sprays and impact comfort. A flow shaping pad 15 is disposed on the water outlet piece 16 to ensure that the water is shaped to an orderly flow by the flow shaping pad 15 before flowing out of the water delivery nozzle 162 of long conical section, thus ensuring water spray effect.

The above descriptions show the preferred embodiments of the present disclosure. As mentioned above, it should be understood that the present disclosure is not limited to the forms disclosed herein and shall not be considered as exclusion to other embodiments but used in various other combinations, modifications or environments and can be changed according to the above teachings or the technologies or knowledge of relevant fields within the conceived scope of the present disclosure. Any modifications or changes made by those skilled in the art without departing from the spirit and scope of the present disclosure shall all fall within the scope of protection of the appended claims of the present disclosure.

1. A rotary sheet-shaped water structure, comprising a shell assembly and a gear assembly disposed inside the shell assembly, the shell assembly comprising a water inlet and a water outlet, and water flowing through the gear assembly through the water inlet and being sprayed out of the water outlet, wherein the water inlet has a plurality of oblique surfaces and the water outlet has a water delivery nozzle having a long conical section.

2. The rotary sheet-shaped water structure of claim 1, wherein the shell assembly comprises a body and a cover body covered on the body, wherein the body has a chamber with an opening disposed at an end, the cover body is covered on the opening, the water inlet is disposed on the cover body, the water outlet is disposed on the body, and the gear assembly is accommodated in the chamber.

3. The rotary sheet-shaped water structure of claim 2, wherein a second sealing ring is disposed between the cover body and the opening.

4. The rotary sheet-shaped water structure of claim 2, wherein a connection wall is convexly disposed at an end of the water inlet away from the body, and a first sealing ring is sleeved on the connection wall.

5. The rotary sheet-shaped water structure of claim 1, wherein the gear assembly comprises a first gear corresponding to the first water inlet and a second gear corresponding to the water outlet, and the first gear is engaged with the second gear.

6. The rotary sheet-shaped water structure of claim 5, wherein a water outlet piece is disposed on the water outlet, the water delivery nozzle with the long conical section is disposed on the water outlet piece, and the long conical section is a rectangular conical section or an obround conical section.

7. The rotary sheet-shaped water structure of claim 6, wherein the second gear is disposed at a side of the water outlet piece close to the water inlet.

8. The rotary sheet-shaped water structure of claim 6, wherein a flow shaping pad is inserted on the water outlet piece, and water flows through the flow shaping pad from the chamber and then flows toward the water delivery nozzle.

9. The rotary sheet-shaped water structure of claim 6, wherein an irregularly-shaped pad is disposed between the water outlet piece and the water outlet.

10. A shower head having the rotary sheet-shaped water structure according to claim 1, comprising a shower head body and a water delivery panel covered on the shower head body, wherein a plurality of water outlet holes are opened on the water delivery panel and the rotary sheet-shaped water structure is disposed on the water outlet holes.

11. The rotary sheet-shaped water structure of claim 2, wherein the gear assembly comprises a first gear corresponding to the first water inlet and the second gear corresponding to the water outlet, and the first gear is engaged with the second gear.

12. The rotary sheet-shaped water structure of claim 3, wherein the gear assembly comprises a first gear corresponding to the first water inlet and the second gear corresponding to the water outlet, and the first gear is engaged with the second gear.

13. The rotary sheet-shaped water structure of claim 4, wherein the gear assembly comprises a first gear corresponding to the first water inlet and the second gear corresponding to the water outlet, and the first gear is engaged with the second gear.

14. The shower head having the rotary sheet-shaped water structure according to claim 10, wherein the shell assembly comprises a body and a cover body covered on the body, wherein the body has a chamber with an opening disposed at an end, the cover body is covered on the opening, the water inlet is disposed on the cover body, the water outlet is disposed on the body, and the gear assembly is accommodated in the chamber.

15. The shower head having the rotary sheet-shaped water structure according to claim 14, wherein a second sealing ring is disposed between the cover body and the opening.

16. The shower head having the rotary sheet-shaped water structure according to claim 14, wherein a connection wall is convexly disposed at an end of the water inlet away from the body, and a first sealing ring is sleeved on the connection wall.

17. The shower head having the rotary sheet-shaped water structure according to claim 10, wherein the gear assembly comprises a first gear corresponding to the first water inlet and a second gear corresponding to the water outlet, and the first gear is engaged with the second gear.

18. The shower head having the rotary sheet-shaped water structure according to claim 17, wherein a water outlet piece is disposed on the water outlet, the water delivery nozzle with the long conical section is disposed on the water outlet piece, and the long conical section is the rectangular conical section or an obround conical section.

19. The shower head having the rotary sheet-shaped water structure according to claim 18, wherein the second gear is disposed at the side of the water outlet piece close to the water inlet.

20. The shower head having the rotary sheet-shaped water structure according to claim 18, wherein a flow shaping pad is inserted on the water outlet piece, and water flows through the flow shaping pad from the chamber and then flows toward the water delivery nozzle.
